(19) United States
(12) Patent Application Publication
(10) Pub. No.: US 2019/0254004 A1
(43) Pub. Date: Aug. 15, 2019

(54) SYSTEM AND METHOD FOR COLLABORATIVELY SELECTING RESOURCES

(71) Applicant: Electronics and Telecommunications Research Institute, Daejeon (KR)

(72) Inventors: Yoo Seung SONG, Daejeon (KR); Do Wook KANG, Daejeon (KR); Shin Kyung LEE, Daejeon (KR); Jeong Woo LEE, Daejeon (KR); Hyun Seo OH, Daejeon (KR)

(73) Assignee: Electronics and Telecommunications Research Institute, Daejeon (KR)

(21) Appl. No.: 16/258,073

(22) Filed: Jan. 25, 2019

(30) Foreign Application Priority Data
Feb. 9, 2018 (KR) 10-2018-0016208

(51) Int. Cl. H04W 72/02; H04W 72/08; H04W 28/02; H04W 28/06

(52) U.S. Cl. CPC H04W 72/02; H04W 72/085; H04W 28/06; H04W 28/0289; H04W 72/087

(57) ABSTRACT

Provided are a system and method for collaboratively selecting resources in which the reliability of transmission data is ensured and the efficiency of a transmission channel is maximized. The system for collaboratively selecting resources includes a packet generator, a selector configured to select resources in consideration of a determinant including at least one of information on a packet and transmission environment information of the packet, and a packet transmitter configured to transmit the packet through the selected resources.

### CROSS-REFERENCE TO RELATED APPLICATIONS

This application claims priority to and the benefit of Korean Patent Application No. 10-2018-0016208, filed on Feb. 9, 2018, the disclosure of which is incorporated herein by reference in its entirety.

### BACKGROUND

The present invention relates to a system and method for collaboratively selecting resources, and more particularly, to a system and method for collaboratively selecting resources, which are capable of ensuring the reliability of transmission data and maximizing the efficiency of a transmission channel.

An interface for exchanging data through hierarchy/function-specific modularization is defined in a communication system according to a related art.

However, the related art does not provide a method for selecting optimal functions (or modules) according to users.

### SUMMARY

The present invention is directed to providing a system and method for collaboratively selecting an optimal combination of available resources (a transmission channel, a channel access method, and a communication system) in order to maximize the efficiency of the transmission channel and ensure the reliability of data transmission along with an increase in the degree of freedom in selection.

According to an aspect of the present invention, there is provided a system for collaboratively selecting resources, the system including: a packet generator; a selector configured to select resources in consideration of a determinant including at least one of information on a packet and transmission environment information of the packet; and a packet transmitter configured to transmit the packet through the selected resources.

According to another aspect of the present invention, there is provided a method of collaboratively selecting resources, the method including: generating a packet to be transmitted; selecting a resource for transmitting the packet by determining at least one of a transmission channel, a channel access method, and a communicator; and transmitting the packet.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1 and 2 are diagrams showing systems for collaboratively selecting resources according to exemplary embodiments of the present invention:

FIG. 3 is a diagram showing a system for collaboratively selecting resources in consideration of packet information according to an exemplary embodiment of the present invention;

FIG. 4 is a diagram showing a system for collaboratively selecting resources in consideration of a degree of congestion of a transmission channel according to an exemplary embodiment of the present invention:

FIG. 5 is a diagram showing a system for collaboratively selecting resources in which the systems shown in FIGS. 3 and 4 are merged together:

FIG. 6 is a diagram showing a system for collaboratively selecting resources according to an exemplary embodiment of the present invention in which a plurality of transmission channels are provided;

FIG. 7 is a diagram showing a system for collaboratively selecting resources according to an exemplary embodiment of the present invention in which a single transmission channel is provided;

FIG. 8 is a diagram showing a system for collaboratively selecting resources in which the systems shown in FIGS. 6 and 7 are merged together;

FIGS. 9 to 12 are diagrams showing systems for collaboratively selecting resources through packet processing according to exemplary embodiments of the present invention;

FIGS. 13 and 14 are diagrams showing systems for collaboratively selecting resources which simultaneously maximize transmission efficiency and transmission reliability according to exemplary embodiments of the present invention; and

FIG. 15 is a flowchart illustrating a method of collaboratively selecting resources according to an exemplary embodiment of the present invention.

FIG. 16 is a view illustrating an example of a computer system in which a method according to an embodiment of the present invention is performed.

### DETAILED DESCRIPTION OF EMBODIMENTS

The aforementioned objects of the present invention, other objects, advantages, characteristics, and methods for achieving them will become apparent with reference to exemplary embodiments described in detail below together with the accompanying drawings.

The present invention may, however, be embodied in various different forms and is not limited to the exemplary embodiments set forth herein. The following exemplary embodiments are provided only to easily disclose the objects, configurations, and effects of the present invention to those of ordinary skill in the art to which the present invention pertains, and the scope of the present invention is defined only by the claims.

Meanwhile, the terminology used herein is for the purpose of describing embodiments only and is not intended to limit the present invention. As used herein, singular terms are intended to include the plural forms as well unless the context clearly indicates otherwise. It will be further understood that the terms “comprises” and/or “comprising”, when used herein, do not preclude the presence or addition of one or more elements, steps, operations, and/or devices other than stated elements, steps, operations, and/or devices.

First, a background of proposing the present invention will be described below to help those of ordinary skill in the art to understand the present invention, and then exemplary embodiments of the present invention will be described.

As cars are connected to a network through wireless communication, they are evolving into connected cars which may provide various services, such as a real-time traffic information service, a safe driving information service, and an infotainment service.

The vehicle to anything (V2X) communication technology for mutually transferring information between a vehicle and a surrounding object (another vehicle, an infrastructure, etc.) or a pedestrian was developed, and thus it is possible to solve not only existing traffic problems but also drivers' problem of safe driving.

In Korea, Korea Expressway Corp. started a HighPass pilot project by using a dedicated short range communication (DSRC) scheme. The HighPass service was widespread throughout the country in 2007, and grown up to a use rate of 80% in 2017.

The DSRC scheme used in the HighPass service has a communication radius of 200 m and a maximum transmission rate of 1 Mbps and supports vehicle-to-infrastructure (V2I) communication.

Due to the performance and characteristics of standards, only services such as provision of simple traffic information and toll collection are supported.

With an increase in technical demands for providing various traffic services and enabling communication between vehicles in a high-speed driving environment, wireless access in vehicular environments (WAVE) standards were developed in 2010.

The WAVE technology allows communication even at a speed of 200 km/h, has a maximum transmission rate of 27 Mbps. and allows data transmission with a delay of 100 ms or less up to a communication radius of 1 km.

The advancement of vehicular communication technology made by the WAVE technology allows provision of various kinds of traffic information and an Internet multimedia service.

Meanwhile, the mobile communication technology which provided pedestrian-oriented voice call, short message, etc. services has advanced again and again and evolved into long term evolution (LTE). Due to the announcement of LTE release 15 in which a delay time is improved, it is currently possible to support the cellular V2X (C-V2X) technology.

Since it is possible to reuse existing infrastructures and lead to fifth generation (5G) communication in the future, C-V2X is attracting attention.

In addition to the aforementioned wireless communication methods, various wireless access technologies are present and used appropriately for respective environments and application services.

International standards for a communications access for land mobiles (CALM) communication structure, which may integratively accommodate such various ground wireless access technologies in the physical layer or the wireless access layer, were developed in 2010.

In Korea, standards for a new communication structure which allows integrative accommodation of wireless access technologies, such as WAVE and LTE, were proposed in Telecommunications Technology Association (TTA) Project Group 905 (PG905) in 2016, and standardization thereof is underway.

Up to now, the flow of these technologies is directed to integratively accommodate various existing wireless access technologies and use upper hierarchies as one common hierarchy.

In other words, standards are provided to appropriately select, when one communication device has several wireless access functions, one of the wireless access functions and wirelessly exchange data.

There are various medium access control (MAC) technologies for distributing resources to respective users. Representatively, in the case of WAVE, carrier sense multiple access with collision avoidance (CSMA/CA) is used as an MAC technology, and time division multiple access (TDMA) is used an LTE technology.

European Telecommunications Standards Institute (ETSI) which is a European standardization organization published self-organizing TDMA (S-TDMA) for ensuring a delay time and the like in an environment without a coordinator, such as a base station, as a technical document in 2011.

As the structure of a communication system is modularized according to a hierarchy or function and a service access point (SAP) for exchanging data with each other is defined, it is possible to customize a communication device and simultaneously use several wireless access technologies in a mixed manner.

However, the related art does not provide a method for selecting optimal functions (or modules) according to users. The present invention is suggested to solve this problem, proposing a system and method for collaboratively selecting an optimal combination of available resources (a transmission channel, a channel access method, and a communication system) to ensure the reliability of transmitted data and maximize the efficiency of the transmission channel in an environment in which a connected car travels.

The present invention proposes i) a system and method for collaboratively selecting resources to maximize the transmission efficiency of a channel, ii) a system and method for collaboratively selecting resources to maximize the transmission reliability of a channel, and iii) a system and method for collaboratively selecting resources to simultaneously maximize the transmission efficiency and transmission reliability of a channel.

Here, the “resources” is a general term encompassing a transmission channel, a channel access method, a communication technology e.g. LTE, WiFi (referred to as a communicator below), etc. required to wirelessly transmit data.

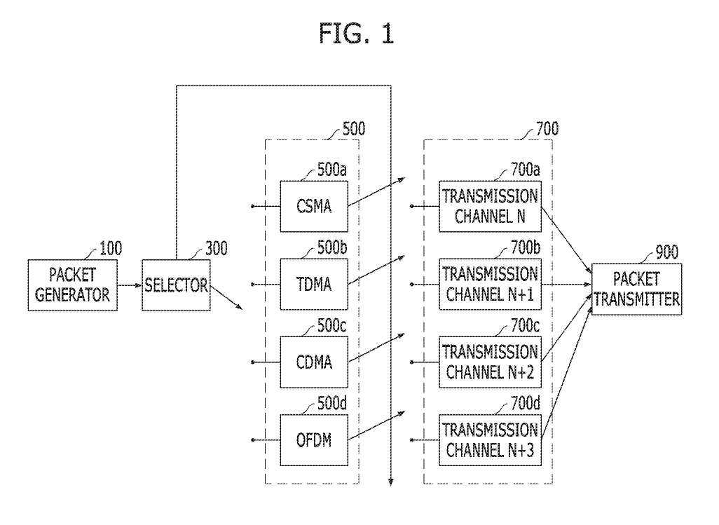

Hereinafter, a system for collaboratively selecting and managing resources by using a determinant to maximize channel transmission efficiency will be described with reference to FIGS. 1 to 8.

According to exemplary embodiments, resources include a transmission channel, a channel access method, and a communicator, and determinants include packet information (a packet cycle, a change in packet length, and a packet type) and transmission environment information of packets (the number of nodes and the degree of channel congestion).

The system for collaboratively selecting resources according to an exemplary embodiment of the present invention includes a packet generator 100, a selector 300 configured to select resources in consideration of a determinant including at least one of packet information and packet transmission environment information, and a packet transmitter 900 configured to transmit a packet through the selected resources.

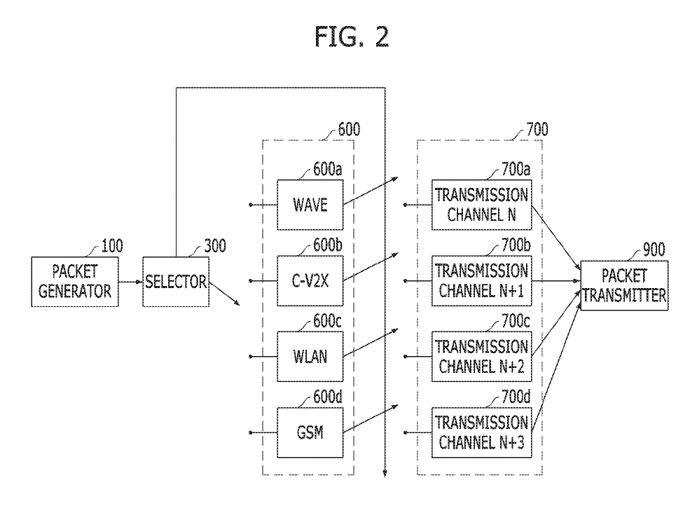

According to an exemplary embodiment of the present invention, a collaborative selection is made by selecting a channel access method 500 or a communicator 600 based on the determinant and linking the selected channel access method 500 or communicator 600 to a transmission channel 700 through which the corresponding packet will be transmitted. FIGS. 1 and 2 are diagrams showing systems for collaboratively selecting resources according to exemplary embodiments of the present invention.

The channel access method 500 includes carrier sense multiple access (CSMA) 500a, time division multiple access (TDMA) 500b, code division multiple access (CDMA) 500c, and orthogonal frequency-division multiplexing (OFDM) 500d, and the communicator 600 includes wireless access in vehicular environments (WAVE) 600a, cellular vehicle to anything (C-V2X) 600b, wireless local area network (WLAN) 600c, and global system for mobile communication (GSM) 600d. These are shown as examples to help those of ordinary skill in the art to understand the present invention, and channel access methods and communicators according to exemplary embodiments of the present invention are not limited thereto.

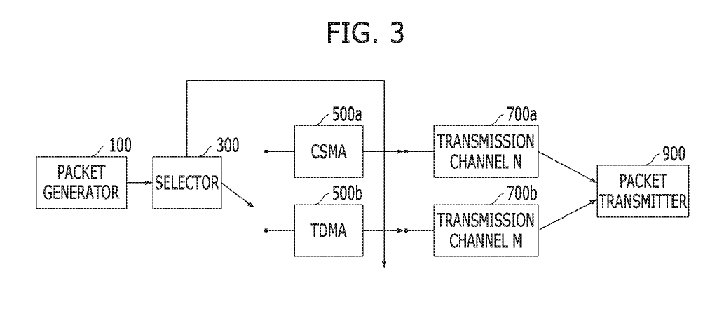

FIG. 3 is a diagram showing a system for collaboratively selecting resources in consideration of packet information according to an exemplary embodiment of the present invention.

The selector 300 according to an exemplary embodiment of the present invention selects resources by considering packet information (a packet cycle, a change in packet length, and a packet type) as determinants.

When transmission packets are generated by the packet generator 100, the selector 300 selects a channel access method 500 in consideration of packet information.

When the packets are a type generated according to an event in a specific vehicle network environment, the selector 300 selects a first channel access method (CSMA) 500a.

On the other hand, when the packets have a fixed generation cycle and length (size), the selector 300 selects a second channel access method (TDMA) 500b.

When the selector 300 selects a channel access method 500 according to characteristics of the generated packets, the selected channel access method 500 is allocated to a transmission channel N 700a or a transmission channel M 700b, and the packet transmitter 900 transmits the packets by using the selected resources.

According to an exemplary embodiment of the present invention, the selector 300 controls both a channel access method 500 and a transmission channel 700.

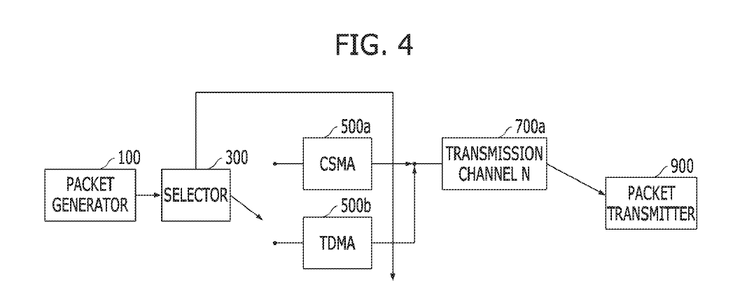

FIG. 4 is a diagram showing a system for collaboratively selecting resources by considering the degree of congestion of a transmission channel as a determinant according to an exemplary embodiment of the present invention.

When transmission packets are generated by the packet generator 100, the selector 300 selects a channel access method 500 by referring to the degree of congestion of a transmission channel as a determinant.

The selector 300 selects the first channel access method (CSMA) 500a when the degree of congestion of the channel is less than a preset threshold value, and selects the second channel access method (TDMA) 500b when the degree of congestion of the channel is equal to or greater than the preset threshold value.

In an exemplary embodiment of the present invention, a channel access method 500 is selected according to the degree of congestion of a transmission channel, and the existing transmission channel N 700a is maintained as a transmission channel 700.

According to an exemplary embodiment of the present invention, the selector 300 controls both a channel access method 500 and a transmission channel 700.

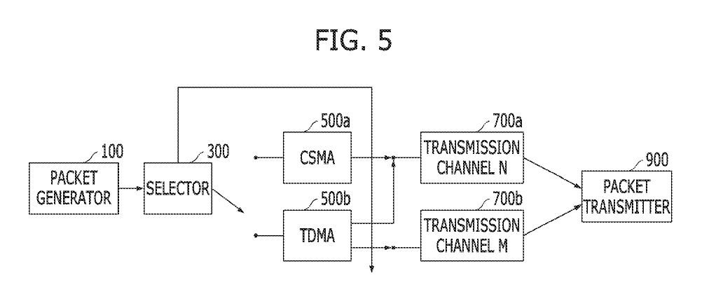

FIG. 5 is a diagram showing a system for collaboratively selecting resources in which the systems shown in FIGS. 3 and 4 are merged together.

In other words, the selector 300 according to an exemplary embodiment of the present invention selects a channel access method 500 in consideration of a determinant, and collaboratively selects a transmission channel 700.

When the degree of congestion of a transmission channel increases, a channel access method for packets which are transmitted to the transmission channel N 700a through the existing first channel access method (CSMA) 500a is changed for the second channel access method (TDMA) 500b, and the transmission channel N 700a is maintained as is, such that resources are collaboratively selected.

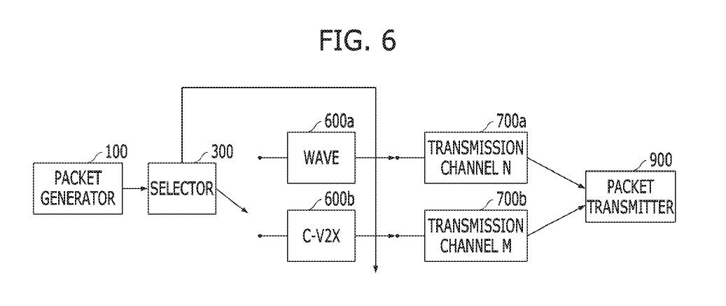

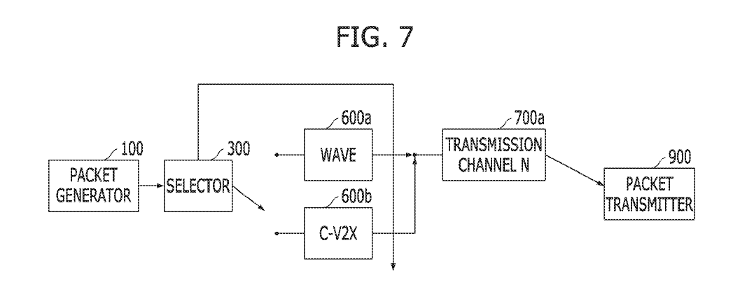

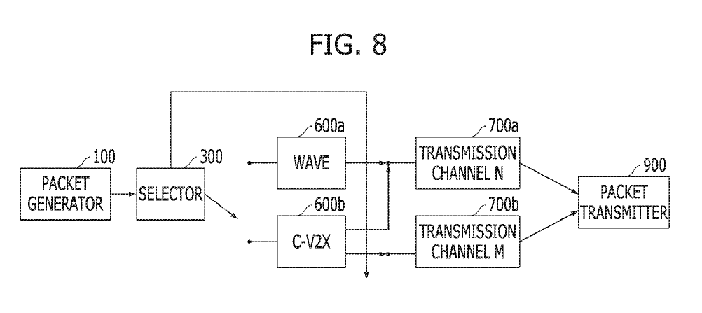

FIG. 6 is a diagram showing a system for collaboratively selecting resources according to an exemplary embodiment of the present invention in which a plurality of transmission channels are provided, FIG. 7 is a diagram showing a system for collaboratively selecting resources according to an exemplary embodiment of the present invention in which a single transmission channel is provided, and FIG. 8 is a diagram showing a system for collaboratively selecting resources in which the systems shown in FIGS. 6 and 7 are merged together.

As shown in FIG. 6, the selector 300 selects a communicator 600 in consideration of a determinant, and a collaborative selection is made so that different transmission channels, the transmission channel N 700a and the transmission channel M 700b, are allocated to the communicator 600.

As the determinant, it is possible to use the type, size (length), and generation cycle of a packet, the degree of congestion of a channel, the number of nodes, a network existing within a communication radius, and the like.

Referring to FIG. 7, when the degree of congestion of a channel is less than the preset threshold value, a first communicator (WAVE) 600a and the transmission channel N 700a are collaboratively selected to transmit a packet. When the degree of congestion of the channel increases equal to or greater than the preset threshold value, the first communicator (WAVE) 600a is changed for a second communicator (C-V2X) 600b, and the transmission channel N 700a is maintained as before.

When the degree of congestion of the channel decreases again, the selector 300 selects the first communicator (WAVE) 600a as the communicator and changes the second communicator (C-V2X) 600b for the first communicator (WAVE) 600a.

As shown in FIG. 8, the selector 300 according to an exemplary embodiment of the present invention selects a communicator 600 in consideration of a determinant, and collaboratively selects a transmission channel 700.

When the degree of congestion of a transmission channel increases, a resource (communicator) for packets which are transmitted to the transmission channel N 700a through the existing first communicator (WAVE) 600a is changed for the second communicator (C-V2X) 600b, and the transmission channel N 700a is maintained as is, such that resources are collaboratively selected.

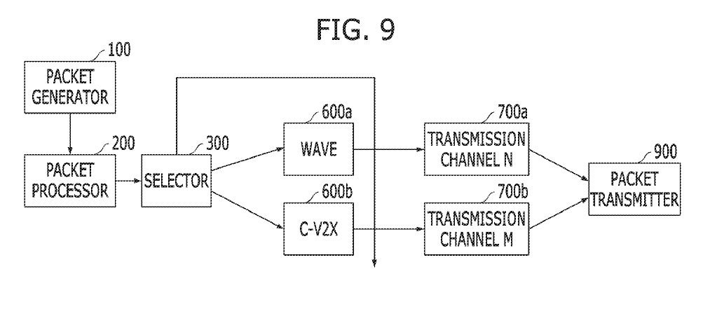

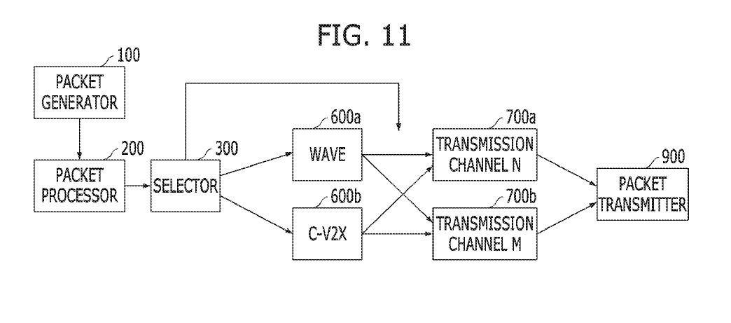

Hereinafter, a system for collaboratively selecting and managing resources by using a determinant to maximize channel transmission efficiency will be described below with reference to FIGS. 9 to 12.

FIGS. 9 to 12 are diagrams showing systems for collaboratively selecting resources through packet processing according to exemplary embodiments of the present invention.

According to an exemplary embodiment of the present invention, a packet processor 200 processes as many packets generated by the packet generator 100 as the number of transmission channels 700, and the selector 300 collaboratively selects resources.

The packet processor 200 processes packets by dividing or duplicating the packets into as many packets as the number of channels.

FIG. 9 shows a process in which the packet processor 200 divides one generated packet into two packets, the number of which is the same as that of transmission channels 700, or redundantly duplicates the packet as many as the number of the transmission channels 700, and the processed packets are transmitted through the communicator 600a or 600b and the transmission channel 700a or 700b which are collaboratively selected.

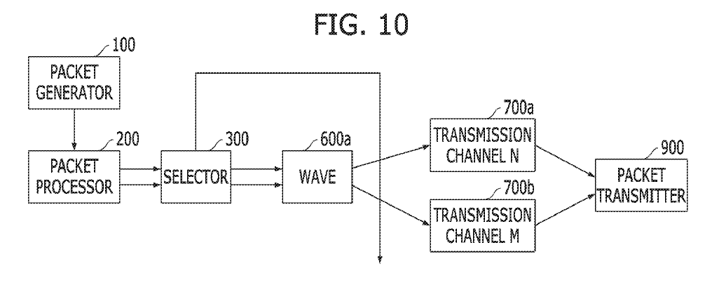

As shown in FIG. 10, the packet processor 200 performs a process of dividing one generated packet into as many packets as the number of the transmission channels 700, or redundantly duplicating the packet as many as the number of the transmission channels 700, and the processed packets are transmitted through the same communicator (WAVE) 600a and a collaboratively selected transmission channel, that is, the transmission channel N 700a or the transmission channel M 700b.

FIG. 1 shows a structure in which the systems shown in FIGS. 9 and 10 are merged.

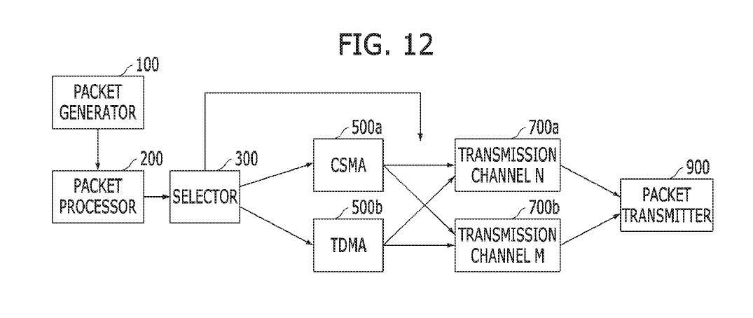

FIG. 12 shows an integrated structure to which a channel access method 500 is applied as a selected resource.

Referring to FIG. 12, in a collaborative resource selection of (A □B) format, A is the number of communicators 600 or channel access methods 500, and B is the number of transmission channels 700 branching from each communicator 600 or channel access method 500.

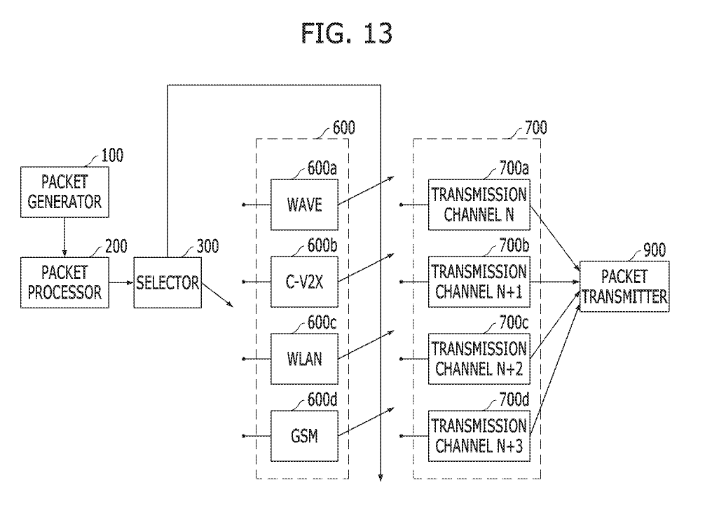

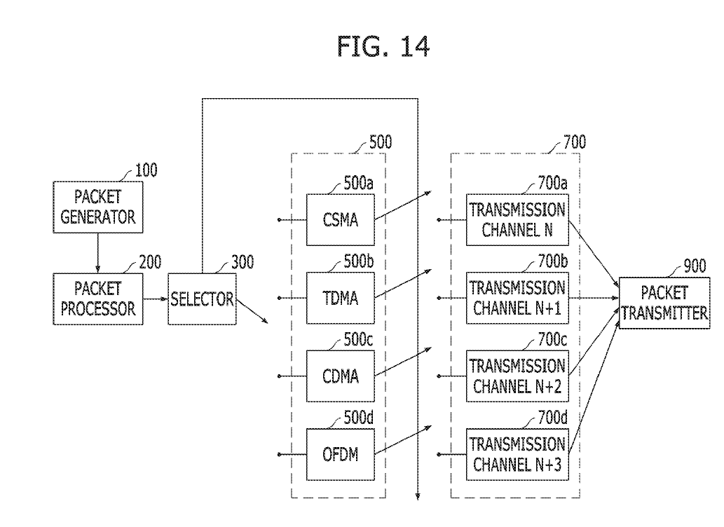

FIGS. 13 and 14 are diagrams showing systems for collaboratively selecting resources which simultaneously maximize transmission efficiency and transmission reliability according to exemplary embodiments of the present invention.

A system which collaboratively selects resources to simultaneously maximize the transmission efficiency and transmission reliability of a channel considers a determinant and processes packets in a manner in which the above-described methods are integrated, thereby collaboratively selecting resources (a channel access method, a communicator, and a transmission channel).

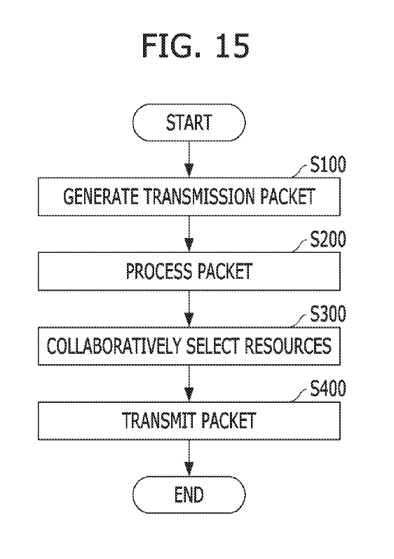

FIG. 15 is a flowchart illustrating a method of collaboratively selecting resources according to an exemplary embodiment of the present invention.

A method of collaboratively selecting resources according to an exemplary embodiment of the present invention includes an operation of generating a packet to be transmitted (S100), an operation of selecting resources (a transmission channel, a channel access method, and a communicator) (S300), and an operation of transmitting the packet (S400).

In operation S300, resources are selected in consideration of a determinant including at least one of packet information and packet transmission environment information. The packet information includes at least one of a packet cycle, length, and type, and the packet transmission environment information includes at least one of the number of nodes and the degree of channel congestion.

According to an exemplary embodiment of the present invention, an operation of dividing the packet generated in operation S100 into as many packets as the number of transmission channels or redundantly duplicating the packet as many as the number of the transmission channels (S200) is further included between operation S100 and operation S300.

The system and method for collaboratively selecting resources according to an exemplary embodiment of the present invention make it possible to collaboratively select resources which are selectable in an entire communication system in consideration of characteristics of data and a transmission purpose and to form an optimal combination

According to the present invention, it is possible to maximize the efficiency and reliability of a transmission channel.

Effects of the present invention are not limited to those mentioned above, and other effects which are not described herein will be clearly understood by those of ordinary skill in the art from the above description.

It should be noted that the scope of the present invention is defined by the claims rather than the description of the present invention, and the meanings and ranges of the claims and all modifications derived from the concept of equivalents thereof fall within the scope of the present invention.

The present invention described above may be embodied as computer-readable code on a program recording medium. The computer-readable medium includes all types of storage devices configured to store data that can be read by a computer system. Examples of the computer-readable medium include a hard disk drive (HDD), a solid-state drive (SSD), a silicon disk drive (SDD), a read-only memory (ROM), a random-access memory (RAM), a compact disc (CD)-ROM, a magnetic tape, a floppy disk, an optical data storage device, and the like. In addition, the computer-readable medium may be implemented in the form of a carrier wave (e.g., transmission through the Internet).

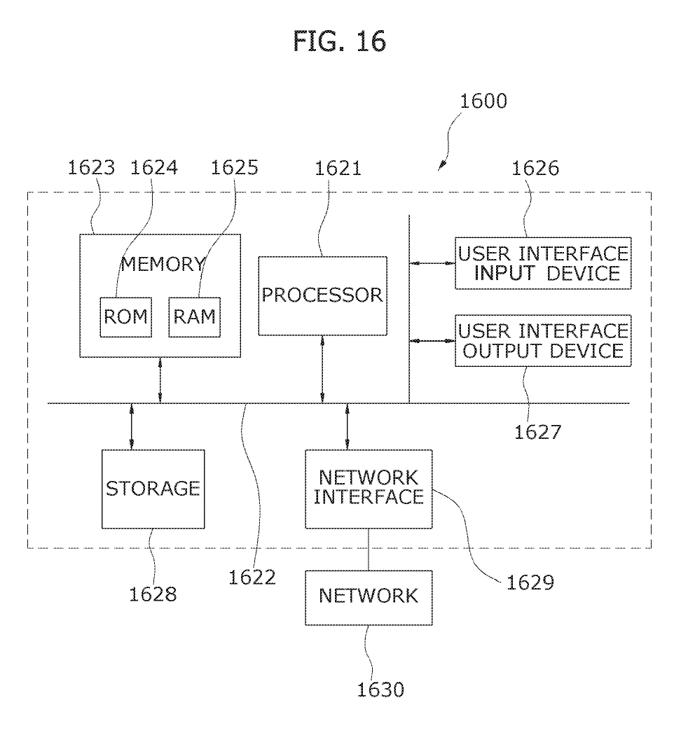

The method according to an embodiment of the present invention may be implemented in a computer system or may be recorded in a recording medium. FIG. 16 illustrates a simple embodiment of a computer system. As illustrated, the computer system may include one or more processors 1621, a memory 1623, a user input device 1626, a data communication bus 1622, a user output device 1627, a storage 1628, and the like. These components perform data communication through the data communication bus 1622.

Also, the computer system may further include a network interface 1629 coupled to a network. The processor 1621 may be a central processing unit (CPU) or a semiconductor device that processes a command stored in the memory 1623 and/or the storage 1628.

The memory 1623 and the storage 1628 may include various types of volatile or non-volatile storage mediums. For example, the memory 1623 may include a ROM 1624 and a RAM 1625.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

Exemplary embodiments of the present invention have been described above. Those of ordinary skill in the art would appreciate that the present invention can be implemented in modified forms without departing from the fundamental characteristics of the present invention. Therefore, exemplary embodiments of the present invention should be construed as describing rather than limiting the present invention. It should be noted that the scope of the present invention is defined by the claims rather than the description of the present invention, and the meanings and ranges of the claims and all modifications derived from the concept of equivalents thereof fall within the scope of the present invention.

What is claimed is:

1. A system for collaboratively selecting resources, the system comprising:
a packet generator;
a selector configured to select resources in consideration of a determinant including at least one of information on a packet and transmission environment information of the packet; and
a packet transmitter configured to transmit the packet through the selected resources.

2. The system of claim 1, wherein the selector selects the resources by determining a transmission channel and at least one of a channel access method and a communicator in consideration of the determinant.

3. The system of claim 2, wherein the selector considers information of the packet including at least one of a cycle, a length, and a type of the packet as the determinant.

4. The system of claim 3, wherein the selector selects a first access channel when the packet is a type generated according to an event, and selects a second access channel when the packet has a fixed cycle and length.

5. The system of claim 4, wherein the selector allocates a separate transmission channel according to the determined channel access method.

6. The system of claim 2, wherein the selector considers the transmission environment information of the packet including at least one of a number of nodes and a degree of channel congestion as the determinant.

7. The system of claim 6, wherein the selector selects a first access channel when the degree of channel congestion is less than a preset threshold value, selects a second access channel when the degree of channel congestion is equal to or greater than the preset threshold value, and maintains the transmission channel as is.

8. The system of claim 6, wherein the selector selects a first communicator when the degree of channel congestion is less than a preset threshold value, selects a second communicator when the degree of channel congestion is equal to or greater than the preset threshold value, and maintains the transmission channel as is.

9. The system of claim 2, further comprising a packet processor configured to process the packet in consideration of a number of transmission channels.

10. The system of claim 9, wherein the packet processor divides the packet into as many packets as the number of transmission channels or redundantly duplicates the packet as many as the number of transmission channels.

11. A method of collaboratively selecting resources, the method comprising:
(a) generating a packet to be transmitted;
(b) selecting a resource for transmitting the packet by determining at least one of a transmission channel, a channel access method, and a communicator; and
(c) transmitting the packet.

12. The method of claim 11, wherein (b) comprises selecting the resource in consideration of a determinant including at least one of information on the packet and transmission environment information of the packet.

13. The method of claim 11, wherein (b) comprises considering information on the packet including at least one of a cycle, a length, and a type of the packet as a determinant and considering transmission environment information of the packet including at least one of a number of nodes and a degree of channel congestion as the determinant.

14. The method of claim 11, further comprising, between (a) and (b), dividing the packet generated in (a) into as many packets as a number of transmission channels or redundantly duplicating the packet as many as the number of transmission channels.

15. A system for collaboratively selecting resources, the system comprising:
a packet generator;
a packet processor configured to process a packet generated by the packet generator in consideration of a number of transmission channels; and
a selector configured to select a channel access method, a communicator, and a transmission channel as resources for transmitting the packet processed by the packet processor.

16. The system of claim 15, wherein the packet processor divides the packet into as many packets as the number of transmission channels or redundantly duplicates the packet as many as the number of transmission channels.
